(19) United States
(12) Patent Application Publication
(10) Pub. No.: US 2008/0206524 A1
(43) Pub. Date: Aug. 28, 2008

(54) Lithographic Printing Plates and Process for Making Same

(76) Inventors: Andre Luiz Arias, Rio de Janeiro (BR); Marjorie Arias, Rio de Janeiro (BR); Mario Italo Provenzano, Rio de Janeiro (BR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/814,722

(22) PCT Filed: Jan. 30, 2006
(86) PCT No.: PCT/IB06/00197

§ 371 Date: Sep. 13, 2007

(30) Foreign Application Priority Data
Jan. 28, 2005 (BR) PI500293-1

(51) Int. Cl. B32B 7/00; C08F 2/46

(52) U.S. Cl. 428/195.1; 427/521

(57) ABSTRACT

The present invention refers to lithographic printing and, in particular, to highly solvent-resistant thermally imaging elements and to methods for using the same as well as to corresponding lithographic printing plates comprising said thermally imageable elements. It also refers to processes for making plates and assemblies for use in lithography. The heat imaging positive array of the present invention comprises: A—a hydrophilic substrate; B—a thermally-sensitive imaging element having a composite structure comprising: (1) a first layer on the substrate and a second layer on the first layer, a) the first layer comprising:—a polymeric material which is insoluble or substantially insoluble in aqueous alkaline developing solutions, modified by a first compound which renders the composition comprising the polymeric material more soluble in alkaline developing solutions; b) a second layer on the first layer, said second layer comprising:—a polymeric material modified by a second compound which renders more soluble or dispersible in aqueous alkaline developing solutions, during the developing process, after heating or through absorbance of electromagnetic radiation; the heated or exposed areas of the assembly becoming significantly more soluble or dispersible in aqueous alkaline developing solutions than the non-imaged or un-imaged areas. Or (2) a pre-mix previously prepared from the components of said first and second layers, wherein said pre-mix is subsequently applied on the substrate as a single layer

### FIELD OF THE INVENTION

This invention refers to lithographic printing and, in particular, to highly solvent-resistant thermally imageable elements and to methods for using the same as well as to corresponding lithographic printing plates comprising said thermally imageable elements.

### BACKGROUND OF THE INVENTION

Compositions used for heat sensitive lithographic printing plates are well-known in the art. Image-wise exposure of such plates through the action of infrared radiation results in a change in the solubility of the composition to the developer, where radiation has been absorbed and converted to heat, whilst the non-exposed areas' solubility to developer remains unchanged. In the case of a positive plate, the area exposed to radiation becomes more developer-soluble while in a negative plate the exposed area becomes less soluble.

U.S. Pat. No. 5,491,046 describes an example of a negative working printing plate containing a radiation sensitive composition, such composition containing a novolak phenolic resin, a resol phenolic resin, a Broensted acid, and an infrared absorber. In the compositions disclosed in that patent, the area exposed to radiation requires a heating step before it can be developed in order to be useable. This is a disadvantage in terms of floor space and process control.

PCT/GB97/01117 disclose a composition for use with a printing plate comprised of an alkali developer-insoluble complex, made up from a phenolic resin and quinoline, benzothiazole, pyridine or imidazoline. When this complex is exposed to infrared radiation, its solubility to alkali developer increases because the heat absorbed breaks down the complex whilst the non-exposed areas remain unaffected. The agents making insoluble the polymer mentioned in that patent are dyes which formulae are described therein.

U.S. Pat. No. 6,326,122 also uses phenolic resins and uses materials that inhibit the solubility of the resin to render the composition less soluble in alkali developer. By increasing the proportion of solubility inhibitor compared to the resin, one increasingly reduces the solubility of the composition but at the same time more thermal energy is required to restore alkali solubility. Thus there is a trade-off between imaging speed and developer resistance. One further disadvantage of this approach is that no matter how much inhibitor is added to the resin, the phenolic resin still remains soluble in solvents used in fount solutions thereby limiting their run length.

In lithographic printing an image is transferred from a printing plate, via an intermediate surface known as a blanket, to paper. The plate image areas are oleophilic and hydrophobic (ink receptive and water repelling) and the non-image areas are oleophobic and hydrophilic (ink repelling and water receptive). The plate is contacted with an emulsion of ink and water and the ink adheres to the image areas and not the hydrophilic substrate whilst the water wets the hydrophilic substrate and not the image areas. It is this inked image that is transferred from plate, to blanket to paper.

Typically it is not water that is used for the emulsion but a solution of water, solvent and surfactants, known as a fount, which is designed to lower the water surface tension thereby allowing the substrate to wet more effectively. The solvent in these founts is usually isopropyl alcohol and whilst effective, it has the disadvantage of being a solvent for the phenolic resins utilized in the above mentioned prior art. This means that for long press run lengths the above compositions need to be baked at a high temperature, typically 250-280° C. for over 1 minute, after development. This again requires the use of a lot of floor space and is expensive to operate due to energy costs. Further, if the process is not controlled well there is a risk of the metal being annealed which would result in plate failure on press and the associated costs of lost production and repair.

There is, therefore, a need for thermally imageable positive working printing plates that have good developer resistance, good photospeed and at the same time good resistance to fount solutions to enable extended run length without baking.

It is therefore a main object of the invention to provide positive printing plates having good resistance to developer, good photo speed while having good resistance to fountain solutions so as to allow long runs without baking.

Still another object of the invention is to provide adequate structures, substances and compositions for forming printing plates able which are to reach the objects and properties herein disclosed.

### SUMMARY OF THE INVENTION

The present invention refers to positive working thermal imaging assembly exhibiting a high resistance to solvent.

The thermal imaging positive working assembly comprises:

A—a hydrophilic substrate;

B—a thermally-sensitive imaging element having a composite structure comprising:

(1) a first layer on the substrate and a second layer on the first layer,
a) the first layer comprising:
   a polymeric material which is insoluble or substantially insoluble in aqueous alkaline developing solutions, modified by a first compound which makes the composition comprising the polymeric material more soluble in alkaline developing solutions;
b) a second layer on the first layer, said second layer comprising:
   a polymeric material modified by a second compound which becomes more soluble or dispersible in aqueous alkaline developing solutions, during the developing process, after heating or through absorbance of electromagnetic radiation; the heated or exposed areas of the assembly becoming significantly more soluble or dispersible in aqueous alkaline developing solutions than areas with no image; or

(2) a pre-mix previously prepared from the components of said first and second layers, wherein said pre-mix is subsequently applied on the substrate as a single layer.

Also described are processes for making the positive working thermal imaging assembly of the present invention,

said process comprising:
(i) applying the first layer of polymeric material onto the substrate;
(ii) modifying said polymeric material which is insoluble or substantially insoluble in aqueous alkaline developing solutions, by compound(s) which makes the polymeric material more soluble in alkaline developing solutions; and
(iii) applying the second layer onto the first layer, which is soluble or dispersible in aqueous alkaline developing solutions, or soluble or dispersible in alkaline developing solution after image-wise heating or exposure and which, when image-wise heated or exposed directly or through absorbance of electromagnetic radiation, the heated or exposed areas of the assembly are rendered significantly more soluble or dispersible in aqueous alkaline developing solutions than the un-image areas; or

said process comprising:
(i) forming a pre-mix by mixing of the polymeric material with the compounds of said first and second layers; and
(ii) applying the pre-mix onto the substrate as a single layer.

The present invention still refers to lithographic printing plates and lithographic printing elements prepared from the thermal imaging assembly described herein.

### MORE DETAILED DESCRIPTION OF THE INVENTION

The invention provides thermal assemblies exhibiting high resistance to solvent. Another embodiment of the invention is the corresponding lithographic printing plates comprising the above-cited lithographic elements containing said first and second layers. This invention also relates to processes for making positive working thermal imaging assemblies, particularly lithographic plates, and the respective imaging elements comprising such first and second polymeric layers.

The positive working thermal imaging assembly comprises:

A—a hydrophilic substrate;

B—a thermally-sensitive imaging element, having composite structure comprising:

(1) a first layer on the substrate and a second layer on the first layer,
a) first layer comprising:
   a polymeric material, which is insoluble or substantially insoluble in aqueous alkaline developing solutions, modified by a first compound which renders the composition comprising the polymeric material more soluble in alkaline developing solutions;
b) a second layer on the first layer, said second layer comprising:
   a polymeric material modified by a second compound, which is rendered more soluble or dispersible in aqueous alkaline developing solutions, during the developing process, after heating or through absorbance of electromagnetic radiation; the heated or exposed areas of the assembly becoming significantly more soluble or dispersible in aqueous alkaline developing solutions than the un-image areas; or

(2) a pre-mix previously prepared from the components of said first and second layers, wherein said pre-mix is subsequently applied on the substrate as a single layer.

Similarly, another object of the present invention is an imaging element, comprising the first and second layers mentioned above.

The thermal imaging assemblies of the invention are based on the finding that a chemical modification, particularly of phenolic resins from the first layer, to render resulting phenolic polymer substantially insoluble in isopropyl alcohol, whilst retaining their ability to be imaged by heat.

Typically, the alkaline developer resistance is very high, and this can modified by reacting the polymer with a reactant which changes a portion of the phenolic hydroxyl groups (pKa ˜10) into functional groups having a pKa lower than 6 and, consequently increase the alkaline solubility thereof.

Alternatively, or in addition to reducing the resin pKa, additional substances may be added to the composition, that also increase resin solubility in alkaline developing solution to the extent that the heat-made imaged areas are readily soluble in alkaline developing solution, while unexposed areas remain substantially insoluble in alkaline developing solution. Surprisingly, the composition remains resistant to isopropyl alcohol usually present in the fountain solution used to reduce surface tension of water, thus allowing the substrate to get wet more effectively.

Another aspect of the invention is a process for preparing a positive working imageable element, by exposing the element image-wise to infrared radiation and contacting the imaged element with aqueous alkaline developing solution in order to develop the image ready for gumming and printing.

The first layer may contain a compound or substance capable of converting light to heat but the second layer may not. Usually, the compound or substance absorbing infrared radiation and changing it into heat is a dye or pigment. Similarly, the second may contain such compound or substance while the first layer may not.

Specifically, laser dye 830 A from Siber Hegner (Switzerland), laser dye S0253 and laser dye S0094 from Few Chemie (Germany) can be mentioned as examples of such dyes or pigments capable of converting light into heat.

The compound capable of converting light to heat may also be present both in the first and second layers of the imageable element. These compounds and substances are usually known in the state of the art and the following compounds can be cited as examples:

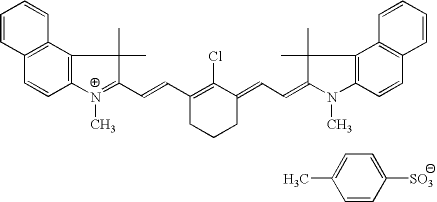

2-[2-[2-Chloro-3-[2-(1,3-dihydro-1,1,3-trimethyl-2H-benzole[e]-indol-2-ylidene)-ethylidene]-1-cyclohexen-1-yl]-ethenyl]-1,1,3-trimethyl-1H-benzo[e]indolium 4-methylbenzenesulfonate

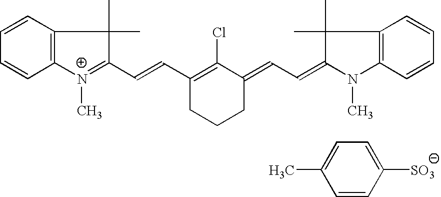

2-[2-[2-Chloro-3-[2-(1,3-dihydro-1,3,3-trimethyl-2H-indol-2-ylidene)-ethylidene]-1-cyclohexen-1-yl]-ethenyl]-1,3,3-trimethyl-3H-indolium 4-methylbenzenesulfonate

The polymeric product in the second layer is derived from the reaction of:

a) a phenolic resin with

b) a second compound which, upon reaction with phenolic resin, reduces the resin solubility in alkaline developer and isopropyl alcohol.

The phenolic resin (resin used as a polymeric material in the first layer, in the second or in the single layer) can be, inter alia, a novalak, resol, polyvinyl phenol or cresol formaldehyde resin.

Examples of said second compound available in the market are:

Monazoline C (1-hydroxyethyl-2-alkyl imidazoline) from Mona Ind., Inc.;

Mackazoline C;

FC-430 (fluorocarbon surfactant) from 3M Corporation;

Zonyl (fluorocarbon surfactant) NS from DuPont;

Solsperse (polymeric amine) from Avecia Pigments and Additives.

The amount of material used for modifying the resol formaldehyde or phenol formaldehyde resin is in the range from 2 to 30% based on the amount of the phenolic polymer and more preferably from 10 to 20%.

The phenolic resins used in the printing elements of invention are therefore modified with a first compound in the presence of dimethylformamide to have its solubility in alkali increased by the fact that a portion of the hydroxyl groups thereof are functionalized with

a) an alkyl or aryl carboxylic acid,

b) an alkyl or aryl sulphonic acid.

More specifically, acetic acid and derivatives thereof, chloroacetic acid, benzoic acid and derivatives thereof, benzenesulphonic acid and derivatives thereof are used as a solubility modifying agent (as the first compound) thereof.

The amount of alkyl or aryl carboxylic acid and alkyl or aryl sulphonic acid employed for modifying the phenolic polymer is from 2 to 30%, preferably from 10 to 20% based on the weight of the polymer.

The present invention still refers to a process a process for making a positive working thermal imaging assembly, which is also an object of the invention, comprising:

A—a hydrophilic substrate;

B—a thermal-sensitive imaging element having a composite structure comprising a first layer on the substrate and a second layer on the first layer.

Said process comprising:
(i) applying, onto the substrate, the first layer of polymeric material modified with the first compound(s) which renders the polymeric material more soluble in alkaline developing solutions; and
(ii) applying the second layer of the polymeric material modified with the second compound onto the first layer, which renders it soluble or dispersible in aqueous alkaline developing solution, during the developing process, after heating or through absorbance of electromagnetic radiation in the near infrared region (830 nm); the heated or exposed areas of the assembly becoming significantly more soluble or dispersible in aqueous alkaline developing solution than the un-imaged areas.

It is still disclosed another process for making a positive working thermal imaging assembly, which is also an embodiment of the present invention, which comprises:

A—a hydrophilic substrate;

B—a thermally-sensitive imaging element having a composite structure comprising a pre-mix previously prepared from the components of said first and second layers (resin and first and second compound as defined above).

Said process comprises:
(i) forming a pre-mix by mixing the polymeric material with the components of said first and second layers; and
(ii) applying the pre-mix onto the substrate as a single layer.

Said process for preparing first and second layer or single layer is usually carried out by dissolving the modified polymers in separate compositions or mixing the modified polymers into a single composition. The modified polymer, both for the first and second layers and for the mixture thereof used as a single layer, must represent preferably from 85 to 99%, preferably in the range from about 90 to 95% based on the weight percent of total solids in the composition.

In the composition of the single layer, the ratio between the modified polymers can vary preferably from 30 to 70%, more preferably from 40 to 60% based on the weight of one polymer to the other.

The infrared absorber can be one or more insoluble dyes or substances such as carbon black. Preferred dyes are those having the structural formulae shown above. Concentration of such dyes used in the compositions are in the range of 0.5 to 10%, preferably 2.0 to 5.0%, based on the total weight of solids in the composition.

Addition of a visible dye to the compositions is always desirable The purpose of using a visible dye in the compositions is to distinguish the image area after development and increase the layer oleophilicity allowing increased acceptance of printing ink. Concentration varies from 0.5 to 3.0% by weight based on the total weight of solids in the composition. Dyes which can be employed are Orasol Blue GN (Ciba Geigy), Pylam Blue LX 11102 (Pylam Products), crystal violet, Flexo Blue 636 (BASF).

The compositions for the first, second and single layers are dissolved in suitable organic solvents, such as: methyl ethyl ketone, 1-methoxy-2-propanol, methyl isobutyl ketone, tetrahydrofuran, butirolactone, ethyl acetate, celosolve and acetone. Preferred concentration of total dissolved solids of the coating solutions for the first, second and single layers is in the range from 6.0 to 25%, preferably 7 to 10% of total dissolved solids.

Hydrophilic substrates used in the present invention are well-known in the art. Metal supports of, inter alia, aluminum, zinc, titanium are included in the usual groups as well as polymer films, paper, laminates, ceramics etc.

The solutions prepared can be applied onto a substrate, such as for example an aluminum plate previously degreased, deoxidized, electrochemically grained, anodized and polyvinyl sulphonic acid-treated, by means known in the art, and hot air dried at a temperature from 65 to 130° C., preferably from 70 to 100° C., for a period from about 30 to about 180 seconds, preferably from about 45 to about 90 seconds.

The amount of solid material in the substrate coating is in the range from 600 mg/m2 to 2 g/m2 and preferably from 1.2 to 16 g/m2.

It is a preferred object of the present invention to use a previously prepared pre-mix of the components for application onto a substrate since such procedure involves the most simplified process steps, resulting in a reduction of general costs of processing.

By using the present invention, faster and more effective printings and end products not exhibiting wear in image areas are obtained.

### EXAMPLES

### Example 1

### Obtaining a Polymer for the 1st Layer (Polymer I)

Into a 1000 ml three-neck bottle reactor, with an agitating bar and a reflux condenser, 400 g dimethylformamide and 100 g formaldehyde cresol resin were introduced. After dissolution was completed, 6,5 g metal potassium (sic) were slowly added to the solution, and the temperature of the solution was raised to 60° C. and kept at this temperature for 12 hours. Then, 15.75 g chloroacetic acid were dissolved in 100 g dimethylformamide and slowly added for a period of 15 minutes, and the temperature was raised to 70° C. and kept at this temperature for 4 hours. The solution was cooled to room temperature, and the polymer precipitated by addition of 2000 ml water, filtered and dried.

### Example 2

### Obtaining a Polymer for the 2nd Layer—(Polymer II)

100 g of formaldehyde cresol resin were dissolved in 300 g isopropyl alcohol. The solution was heated at 75° C., and 10 g Mackazoline C were added. After 2 hours, bath temperature was reduced to room temperature and 2000 ml water were added. The precipitated polymer was filtered, washed with 1000 ml water and dried.

### Example 3

A coating solution was prepared by dissolving 4 g polymer 1, 5 g polymer II, 0.125 g laser dye S0094 (supplied by FEW Chemie, Germany), 0.04 g laser dye S0253 (Few Chemie, Germany) and 0.6 g dye Orasol Blue (Ciba Geigy) in 60 g 1-methoxy propanol and 20 g methyl ethyl ketone. An aluminum substrate which has been degreased, electrochemically grained, anodized and made hydrophilic by a polyvinyl phosphonic acid treatment, as well-known by those skilled in the art, was coated with the composition described above. After properly dried, the plate was placed on an imaging device Creo Tendsetter and imaging was carried out in the mode “write non-image area”, by using exposures from 120 to 170 mJ/cm² with increments of 10 mJ/cm². The plate was developed by a processing machine loaded with positive developer IBF-M2. Image resolution based on UGRA scale was from 2 to 98% at an exposure of 150 mJ/cm². The plate was placed on a printing machine using fountain solution containing isopropyl alcohol and printed about 100,000 copies showing no wear on the image area.

### Example 4

Another coating solution was prepared by dissolving 5.5 g polymer I, 0.15 g laser dye S0094 (FEW Chemie, Germany), 0.05 g laser dye S0253 (Few Chemie, Germany) and 0.5 g dye Pylam Blue LX-11102 (Pylam Products Company, NY) in 60 g 1-methoxy propanol in 20 g methyl ethyl ketone. An aluminum substrate, obtained as described in the previous example, was coated with the composition which after drying represented 520 mg/m². Applied onto the first layer was a second coating prepared by dissolving 7.0 g polymer II, 0.19 g laser dye S0253 (Few Chemie, Germany), 0.063 g laser dye S0253 (Few Chemie, Germany) and 0.5 g dye Orasol Blue (Ciba Geigy) in 60 g 1-methoxy propanol in 20 g methyl ethyl ketone. After drying the estimated weight of the second layer was 925 mg/m2.

Following the procedure of the previous example, the plate was placed on an imaging device Creo Tendsetter, imaging was carried out and processed with developer IBF-M2.

Image resolution based on UGRA scale was from 2 to 98% at an exposure of 150 mJ/cm². The plate was placed on a printing machine using fountain solution containing isopropyl alcohol and printed about 150,000 copies showing no wear on the image area.

### Example 5

Another plate was prepared precisely as prepared in example 3. After development an IBF oven solution was applied and after drying it was subject to heat cure for 5 minutes at 230° C. Under standard printing conditions the plate was seen to print approximately 750,000 copies showing no wear at all.

### Example 6

This example shows the coating composition resistance to isopropyl alcohol and substitutes thereof in a fountain solution for printing machine. Printing plates were prepared coated as described in examples 3 and 4.

The coated plates were exposed to an imaging device Creo Trendsetter by setting the exposure energy to 150 mJ/cm² having a dot image model of 50%. The plates were developed with an automatic processor loaded with developer IBF Million 2, washed and dried.

Subsequently, strips measuring 10 cm×30 cm were cut which were dipped in isopropyl alcohol at 2 minute intervals. The strips were dried with a paper towel and measurements were carried out by a densitometer ccDot on the areas exposed to isopropyl alcohol and compared to the unexposed area. The following values were found:

| | Time in minutes | | | | | |
|---|---|---|---|---|---|---|
| | 0 | 2 | 4 | 6 | 8 | 10 |
| Example 1 % density | 49.0 | 48.1 | 47.8 | 47.2 | 45.8 | 45.8 |
| Example 2 % density | 48.8 | 48.0 | 47.4 | 47.0 | 46.2 | 45.0 |

### Example 7

Another set of plates having a dot image model of 50% was obtained according to the procedure above. Strips measuring 10 cm×30 cm were cut and dipped for several times in an IBF fountain solution prepared by diluting 1:50 in water and containing 15% isopropyl alcohol and another fountain solution prepared in the same way but substituting 1.5% Green Diamond AR, a product supplied by Rycoline Products, Inc., for isopropyl alcohol. After being exposed for a certain period of time, the plates were dried and reading of % density were made by a densitometer ccDot. The results are shown in the table below.

| | | Time in hours | | | |
|---|---|---|---|---|---|
| | | 0 | 24 | 48 | 72 |
| Example 1 | 15% isopropyl alcohol | 49.5 | 49.5 | 49.5 | 49.3 |
| (% density) | 1.5% Green Diamond AR | 49.5 | 49 | 49 | 49 |
| Example 2 | 15% isopropyl alcohol | 48.4 | 48.4 | 48.4 | 48.3 |
| (% density) | 1.5% Green Diamond AR | 48.4 | 48.3 | 48.0 | 48.0 |

### Example 8

A further test was carried out with the same specimens of plates coated as described in examples 3 and 4 and which were dipped in fountain solutions as described in example 7, for adherence of dots to the substrate after the dipping period, using a tape which was removed after adhering to the layer. No visual damages caused by the tape were seen on the coat of the specimens, which can be confirmed by readings using densitometer ccDot.

1. A positive working thermal imaging assembly, comprising:
A—a hydrophilic substrate;
B—a thermally-sensitive imaging element having a composite structure comprising:
(1) a first layer on the substrate and a second layer on the first layer,
a) the first layer comprising:
a composition having a first polymeric material which is insoluble or substantially insoluble in aqueous alkaline developing solutions and is modified by a first compound which renders the composition comprising the first polymeric material more soluble in alkaline developing solutions;
b) a second layer on the first layer, said second layer comprising:
a composition having a second polymeric material, modified by a second compound, which renders more soluble or dispersible in aqueous alkaline developing solutions, during the developing process, after heating or through absorbance of electromagnetic radiation; and wherein heated or exposed areas of the assembly are significantly more soluble or dispersible in aqueous alkaline developing solutions than unimaged areas; or
(2) a pre-mix previously prepared from the compositions of said first and second layers, wherein said pre-mix is subsequently applied on the substrate as a single layer.

2. The assembly as claimed in claim 1, wherein the first layer contains a compound or substance capable of converting light into heat, and wherein the second layer does not contain such a compound or substance.

3. The assembly as claimed in claim 2, wherein the compound or substance capable of converting light into heat is a dye or pigment.

4. The assembly as claimed in claim 1, wherein the second layer contains a compound or substance capable of converting light into heat, and wherein the first layer does not contain such a compound or substance.

5. The assembly as claimed in claim 4, wherein the compound or substance capable of converting light into heat is a dye or pigment.

6. The assembly as claimed in claim 1, wherein both first and second layers contain a compound or substance capable to convert light into heat.

7. The assembly as claimed in claim 6, wherein the compound or substance capable of converting light into heat is a dye or pigment.

8. The assembly as claimed in claim 1, wherein the substance is a hydrophilic substrate.

9. The assembly as claimed in claim 1, wherein the first and second polymeric materials are not substantially soluble in isopropyl alcohol.

10. The assembly as claimed in claim 9, wherein the first and second polymeric materials are derived from the reaction of:
a) a phenolic resin and
b) a compound which, upon reaction with the phenolic resin, reduces resin solubility in alkaline developer and isopropyl acid.

11. The assembly as claimed in claim 10, wherein the phenolic resin is a novalak, resol, polyvinyl phenol or cresol formaldehyde.

12. The assembly as claimed in claim 10, wherein the second compound is Monazoline C, Solsperse or FC430.

13. The assembly as claimed in claim 10, wherein the phenolic resin has its solubility increased by functionalizing a portion of the hydroxyl groups thereof with a compound selected from the group consisting of:
a) an alkyl or aryl carboxylic acid, and
b) an alkyl or aryl sulphonic acid.

14. A process for making a positive working thermal imaging assembly, comprising:
A—a hydrophilic substrate;
B—a thermally-sensitive imaging element having a composite structure comprising a first layer on the substrate and a second layer on the first layer, said process comprising:
(i) applying, onto the substrate, the first layer comprising a composition having a first polymeric material modified with a first compound(s) which renders the first polymeric material more soluble in alkaline developing solutions; and
(ii) applying the second layer onto the first layer, the second layer comprising a composition having a second polymeric material and a second compound that renders the second polymeric material soluble or dispersible in aqueous alkaline developing solution, during the developing process, after heating or through absorbance of electromagnetic radiation; and wherein heated or exposed areas of the assembly become significantly more soluble or dispersible in aqueous alkaline developing solution than non-imaged or unimaged areas.

14. (canceled)

15. The process as claimed in claim 14, wherein the first layer contains a compound or substance capable of converting light into heat, and wherein the second layer does not contain such a compound or substance.

16. The process as claimed in claim 15, wherein the compound or substance capable of converting light into heat is a dye or pigment.

17. The process as claimed in claim 14, wherein the second layer contains a compound or substance capable of converting light into heat, and wherein the second layer does not contain such a compound or substance.

18. The process as claimed in claim 17, wherein the compound or substance capable of converting light into heat is a dye or pigment.

19. The process as claimed in claim 14, wherein both first and second layers contain a compound or substance capable to convert light into heat.

20. The process as claimed in claim 19, wherein the compound or substance capable of converting light into heat is a dye or pigment.

21. The process as claimed in claim 14, wherein the first and second polymeric materials are not substantially soluble in isopropyl alcohol.

22. The process as claimed in claim 14, wherein step (i) is carried out by reacting a phenolic resin as the first polymeric material of the first layer with a compound which, upon reaction with the phenolic resin, reduces resin solubility in alkaline developer and isopropyl alcohol.

23. The process as claimed in claim 22, wherein the phenolic resin is a novolak, resol, polyvinyl phenol or cresol formaldehyde resin.

24. The process as claimed in claim 22, wherein the compound which makes resin less soluble is Monazoline C, Mackazoline C, Solsperse or FC430.

25. The process as claimed in claim 22, wherein the phenolic resin has its solubility increased by the fact that a portion of the hydroxyl groups thereof are functionalized with said first compound selected from the group consisting of:
a) an alkyl or aryl carboxylic acid, and
b) an alkyl or aryl sulphonic acid.

26. A lithographic printing plate comprising the thermal imaging assembly of claim 1.

27. A lithographic printing element comprising the thermal imaging assembly of claim 1.

28. A process for making a positive working thermal imaging assembly, comprising:
forming a pre-mix by mixing a composition having a first polymeric material which is insoluble or substantially insoluble in aqueous alkaline developing solutions and is modified by a first compound which renders the composition comprising the first polymeric material more soluble in alkaline developing solutions with a composition having a second polymeric material, modified by a second compound which becomes soluble or dispersible in aqueous alkaline developing solutions, during the developing process, after heating or through absorbance of electromagnetic radiation; and
(ii) applying the pre-mix onto a hydrophilic substrate as a single layer to form a thermally-sensitive imaging element thereon.
